(19) United States
(12) Patent Application Publication
(10) Pub. No.: US 2004/0009872 A1
(43) Pub. Date: Jan. 15, 2004

(54) Method using solvents for improved microporous polymeric adsorbents

(76) Inventors: Gordon Cohen, Wynnewood, PA (US); Vidya Pai, Wilmington, DE (US); Irene Plotzker, (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/195,936

(22) Filed: Jul. 15, 2002

(51) Int. Cl. B01J 20/26; C08F 118/02

(52) U.S. Cl. 502/402; 526/319

(57) ABSTRACT

The present invention provides a polymerization method using specified solvents to produce improved microporous polymers for separating flavonoids from dilute aqueous solution by adsorption.

### FIELD OF THE INVENTION

The present invention relates to methods for using solvents to produce improved microporous polymeric materials for use in separating flavonoids from dilute aqueous solution by adsorption.

### BACKGROUND OF THE INVENTION

Dietary isoflavones have been found to have health benefits. For example, they are believed to be responsible for the cholesterol-lowering effect of soy products (Anthony et al., Circulation 91:925 (1995), and Anthony et al., J. Nutr. 126:43 (1996)). They may help prevent breast cancer (see e.g., Adlercreutz et al., J. Nutr. 125:757S-770S (1995), and Peterson and Barnes, Biochem. Biophys. Res. Communications 179(1): 661-67 (1991)). They are believed to ameliorate menopausal symptoms (Adlercreutz et al., The Lancet, 339:1233 (1992)). U. S. Pat. No. 5,972,995 teaches the treatment of cystic fibrosis patients by administering isoflavones capable to stimulate chloride transport.

Isoflavones are colorless, crystalline ketones found primarily in leguminous plants. One of the most important sources of isoflavones is the soybean, which contains twelve distinct isoflavones: genistein, genistin, 6″-O-malonylgenistin, 6″-O-acetylgenistin, daidzein, daidzin, 6″-O-malonyidaidzin, 6″-O-acetyidaidzin, glycitein, glycitin, 6″-O-malonylglycitin, 6″-O-acetylglycitin (Kudou, Agric. Biol. Chem. 55, 2227-2233 1991). These soybean isoflavones share the generic structure shown below:

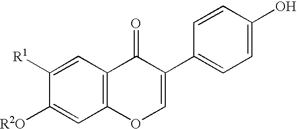

where R¹=H, OH, or OCH₃;

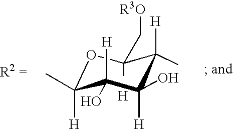

R³=H, CH₃C(O) or HOOCCH₂C(O)

Soybean processing technology is reviewed in Soybeans-Chemistry, Technology, and Utilization, by KeShun Liu (Chapman & Hall, New York, 1997). Soy protein isolates are typically prepared from defatted soy meal. Proteins and soluble carbohydrates are extracted into aqueous solution (pH 7-10). The insoluble residue is mostly carbohydrate and is removed by centrifugation. The protein is precipitated from solution as curd at its isoelectric point (about pH 4.5), further purified, neutralized, and dried. The liquid remaining after the protein has been isolated is referred to as whey and contains mainly soluble carbohydrates. Most of the isoflavones are retrieved with the protein curd. However, isoflavones also exist at the ppm level in the whey. Given the high value of isoflavones, an efficient and selective process for isolating them from soy whey would be highly desirable.

A process for separating specific isoflavone fractions from soy whey and soy molasses feed streams is described in U.S. Pat. Nos. 6,261,565; 6,033,714; 5,792,503; and 5,702, 752. “Soy molasses” (also referred to as “soy solubles”) is obtained when vacuum distillation removes the ethanol from an aqueous ethanol extract of defatted soy meal. The feed stream is heated to a temperature chosen according to the specific solubility of the desired isoflavone fraction. The stream is then passed through an ultrafiltration membrane, which allows isoflavone molecules below a cutoff molecular weight to permeate. The permeated isoflavone molecules then may be concentrated using a reverse osmosis membrane. The concentrated isoflavone stream is then put through a resin adsorption process using at least one liquid chromatographic column to further separate the fractions. Amberlite®(D XAD-4 polymeric adsorbent (Rohm and Haas, Philadelphia, Pa.) is described in U.S. Pat. No. 6,033,714 as particularly attractive for the chromatography columns. XAD-4 has been described as a hydrophobic, crosslinked styrene divinylbenzene polymer (Kunin, Polym. Sci. and Eng., 17(1), 58-62 (1977)). XAD-4 has good stability and its characteristic pore size distribution makes it suitable for adsorption of organic substances of relatively low molecular weight. However, as disclosed in U.S. Pat. No. 6,033,714, other adsorptive resins may be used in the chromatography columns.

Ju et al. (Biotechnol. Bioeng., 64(2), 232 (1999)) used molecularly imprinted polymers to selectively bind and recover secondary metabolites from fermentation. Molecular imprinting introduces selective recognition sites into highly crosslinked polymer matrices by carrying out polymerization in the presence of a template molecule, which is identical to or closely resembles the species one wishes to adsorb from a dilute stream. The template molecule forms noncovalent complexes or labile bonds with the polymer matrix and can be removed after the polymerization, leaving behind cavities or “prints” matching the template molecule. In these prints, the polymer's functional groups are positioned to recognize and selectively bind the desired molecule from the feed stream. Ju et al. used soluble pigments produced by a fungus as model compounds. Polymer matrices were made with one of two functional monomers (2-methacryl-amido-6-picoline or 4-aminostyrene) and one of two crosslinkers (ethylene glycol dimethacrylate or trimethylolpropane trimethacrylate) in one of two polymerization solvents (acetonitrile or tetrahydrofuran). The authors found the effect of polymerization solvent on uptake to be variable and not predictable.

In U. S. Patent Application No. 60/272,841, molecularly imprinted polymers are used to adsorb isoflavones from soy whey. The improved process for producing the molecularly imprinted polymers comprises introducing a reaction mixture of one or more template molecules, one or more functional monomers, one or more crosslinking monomers, a polymerization initiator system, and optionally one or more other monomers, into a suspending medium, under such conditions that the reaction mixture rapidly forms a suspension of molecularly imprinted polymer particles in the suspending medium. The exemplified molecularly imprinted polymers showed enhanced isoflavone adsorption versus an analogous molecularly imprinted polymer prepared via conventional suspension polymerization.

A porogenic solvent (“porogen”) can be present in the reaction 35 mixture of U.S. Patent Application No. 60/272,841 at about 1 to 50 volume percent. The porogen should have a solubility parameter within 2 MPa^{1/2} (preferably within 1 MPa^{1/2}) of the forming polymer. The solubility parameter used therein is a total solubility parameter, as defined below. Porogens claimed include acetone, chloroform, toluene, cyclohexanol, dodecylalcohol, acetonitrile, N-methylpyrrolidone, tetrahydrofuran, and ethyl acetate. However, none of these is singled out as more preferred. The porogen in the '841 Examples was a mixture of cyclohexanol and dodecylalcohol that was 90.5% cyclohexanol by weight.

It is desired to be able to predict the most effective porogens to be included in the reaction mixture for the polymerization of microporous polymers for adsorption of flavonoids, especially isoflavones, from dilute aqueous solution.

### SUMMARY OF THE INVENTION

Accordingly, this invention provides an improved polymerization process for producing microporous polymers that will effectively adsorb flavonoids from dilute aqueous solution, even in the absence of molecular imprinting. This method for preparing a porous polymer adsorbent comprises contacting a polymerization initiator with a reaction mixture comprising

(i) at least 25 mol % of one or more polyfunctional methacrylate monomers, each monomer containing at least three methacrylate groups, or at least 50 mole % of one or more dimethacrylate monomers, or a mixture thereof,

(ii) between about 5 to 25 mol % of one or more acid monomers,

(iii) optionally, one or more polymerizable monomers selected from the group consisting of styrene, phenoxyethyl methacrylate, alkyl methacrylate, and arylalkyl methacrylates; and

(iv) a porogenic solvent having a Hoy polar solubility parameter ranging from about 5 to about 12 MPa^{1/2} and comprising at least 25% by volume of the organic phase of the mixture.

The polymerization initiator is heat, light, azo free radical compounds, peroxides, or a redox system. The porogenic solvent comprises at least 50 vol % of the organic phase of the reaction mixture and preferably at least 70 vol % of the organic phase of the reaction mixture. The porogenic solvent may be an alkyl acetate (e.g., ethyl acetate, propyl acetate, or butyl acetate) wherein the alkyl group contains between 1 and 10 carbon atoms or may be an alcohol containing between 4 and 10 carbon atoms (e.g., 1-butanol, 1-pentanol, or 1-hexanol). The porogenic solvent has a Hoy polar solubility parameter ranging from about 5 to 12 MPa^{1/2} preferably about 7 to about 11 MPa^{1/2}, and more preferably ranging from about 7.5 to about 10 MPa^{1/2}.

The acid monomer of the present invention is selected from the group consisting of methacrylic acid, acrylic acid, itaconic acid, maleic acid, fumaric acid, cinnamic acid, and p-hydroxycinnamic acid. The polymerizable monomer in the present invention is preferably selected from the group consisting of styrene, phenoxyethyl methacrylate, alkyl methacrylate, and arylalkyl methacrylate.

A microporous polymer adsorbent may also be produced where the reaction mixture further comprises an aqueous phase. The aqueous phase preferably includes a suspending agent at 0.05-1% by weight of the water, a protective colloid at 0.05-1% by weight of the water, and/or various aqueous additive(s). Preferably the suspending agent is selected from the group consisting of hydroxyethyl cellulose, hydroxymethyl cellulose, hydroxypropyl cellulose, carboxymethyl cellulose, poly(vinyl alcohol), sodium lauryl sulfate, sodium polyacrylate, polyacrylic acid, polymethacrylic acid, sodium polymethacrylate, and dodecyl alcohol.

The microporous polymers produced from these methods are used for separating flavonoids (and particularly distinct isoflavones) from dilute aqueous media. The method includes contacting an aqueous medium containing isoflavones with a porous polymer produced by the solution or suspension methods disclosed herein for a time sufficient to adsorb the isoflavones onto the porous polymer, and then desorbing the isoflavones from the microporous polymer.

### BRIEF DESCRIPTION OF THE FIGURES

FIG. 1 shows isoflavone uptake at 1 ppm loading for polymers on the y-axis versus the Hoy polar solubility parameter of the polymerization solvent on the x-axis. A calculation trendline is included. R² denotes the fraction of variability in uptake accounted for by the trendline fit.

FIG. 2 shows isoflavone uptake at 1 ppm loading for polymers on the y-axis versus the Hoy total solubility parameter of the polymerization solvent on the x-axis. A calculation trendline is included. R² denotes the fraction of variability in uptake accounted for by the trendline fit.

FIG. 3 shows isoflavone uptake at 5 ppm loading for polymers on the y-axis versus the Hoy polar solubility parameter of the polymerization solvent on the x-axis. A calculation trendline is included. R² denotes the fraction of variability in uptake accounted for by the trendline fit.

FIG. 4 shows isoflavone uptake at 5 ppm loading for polymers on the y-axis versus the Hoy total solubility parameter of the polymerization solvent on the x-axis. A calculation trendline is included. R² denotes the fraction of variability in uptake accounted for by the trendline fit.

### DETAILED DESCRIPTION OF THE INVENTION

According to the present disclosure, a new technique is provided for synthesizing adsorptive, microporous polymers. The present invention uses specified solvents to produce microporous polymers with improved adsorption characteristics compared to microporous polymers prepared in other solvents. The resulting microporous polymer has utility as an adsorbent to remove isoflavones from an aqueous (fermentation) medium.

One of the most common polymerization methods is free radical polymerization (e.g., the polymerization of vinyl monomers in the presence of a free radical source). The free radical source is often a compound that decomposes to yield free radicals upon heating to a characteristic temperature. The free radicals then catalyze the polymerization of the monomer(s) present. This method may be used to prepare the polymers of the present invention. Alternatively, the free radical polymerization may be effected with photoinitiators and, optionally, photosensitizers mixed into the reaction mixture, then exposing this mixture to light.

The polymerizations may be run in an organic medium, comprising monomers, porogen, and initiator, or in suspension, comprising monomers, porogen, initiator, and other additives suspended in droplet form in an immiscible liquid like water. For the polymerization methods mentioned above, see Polymer Handbook (editors: J. Brandrup, E.H. Immergut, and E. A. Grulke, fourth edition, J. Wiley & Sons, 1999).

Thermal free radical initiators useful in the present invention include, but are not limited to, azonitrile initiators (e.g., 2,2′-azo-bis-isobutyronitrile), alkyl peroxides (e.g., tert-butyl peroxide), and acyl peroxides (e.g. benzoyl peroxide).

Additives that can be used to make an aqueous suspension (i.e., when the organic components are polymerized in water) include, but are not limited to, any or all of the following, added at about 0.05 to 5 wt % relative to water:

1. Suitable suspending agents such as hydroxyethyl cellulose, hydroxymethyl cellulose, hydroxypropyl cellulose, carboxymethyl cellulose, poly(vinyl alcohol), sodium lauryl sulfate, sodium polyacrylate, polyacrylic acid, polymethacrylic acid, sodium polymethacrylate, and dodecyl alcohol.

2. A protective colloid such as gelatin.

3. Other optional aqueous additives such as, but not limited to, sodium chloride, and/or pH adjusters (e.g., ammonium hydroxide, potassium hydroxide, and sodium hydroxide).

The following definitions apply in the application, unless specifically stated otherwise:

The term “reaction mixture” refers to a mixture comprising one or more functional monomers, one or more polyfunctional crosslinking monomers, a polymerization initiator system, optionally one or more other monomers, and solvents, including porogens.

“Polyfunctional crosslinking monomers” are those monomers containing two or more sites that can take part in a polymerization process. These are often referred to as di-, tri-, tetra-, etc., functional monomers. For example, for polymerizing acrylate-type monomers, a difunctional crosslinker such as ethylene glycol dimethacrylate can be used. Examples of polymethacrylate (tri- and higher) crosslinkers include, but are not limited to, trimethylolpropane trimethacrylate, glycerol trimethacrylate, pentaerythritol trimethacrylate, and pentaerythritol tetramethacrylate, preferably 70-85 mol %. Dimethacrylate crosslinkers when used are 50 to 95 mol % of the monomers present. When polymethacrylates are used, they are present at 25 to 95 (preferably 40 to 85) mol % of the monomers present. Crosslinkers with methacrylate polymerization sites are most preferred. “Functional monomers” are those monomers containing groups that interact with other groups on the isoflavone molecules that are being adsorbed. The groups on the “functional monomers” can also interact with other groups on template molecules, when template molecules are used, thereby assisting in forming polymer with a molecular imprint. Monomers with acid functionality are preferred. Methacrylic and acrylic acids are more preferred. Methacrylic acid is most preferred. “Other monomers” are monomers herein that are not functional monomers or polyfunctional crosslinking monomers as defined herein. Preferred other monomers are selected from the group consisting of acrylics, methacrylics, styrenes, and other acid monomers. By an acrylic monomer is meant a monomer derived (at least in part) from acrylic acid, including acrylic acid itself. These include acrylic acid esters, amides, and acrylonitrile. By a methacrylic monomer is meant a monomer derived (at least in part) from methacrylic acid, in a manner analogous to that of acrylic acid. By a styrene monomer is meant a compound having a vinyl group attached to an aromatic ring, especially styrene itself, divinylbenzene, and α-methylstyrene. Examples of “other acidic monomers” are itaconic acid, maleic acid, fumaric acid, cinnamic acid, and p-hydroxycinnamic acid. Styrene and esters of methacrylic acid are preferred “other monomers”. Methacrylic and acrylic acids are more preferred “functional monomers”, and methacrylic acid is most preferred.

The term “porogen” refers to a compound or compounds that are miscible in the reaction mixture, but are not meant to be monomers or template molecules. They include liquids with a polar solubility parameter between 5 and 12 MPa^{1/2}, more preferably between 7 and 11 MPa^{1/2}, and most preferably between 7.5 and 10 MPa^{1/2}. The presence of the porogen yields a polymer with higher surface area than results in the porogen's absence. It is preferred that the porogen, also referred to as “porogenic solvent”, be 25-85 percent by volume (vol %), preferably 50-80 percent by volume (vol %) of the combined volume of the solvents, monomers and crosslinkers.

The terms “alkyl” and “arylalkyl” are used in the conventional manner.

The term “droplet” refers to a finite volume of liquid with approximate spheroidal morphology.

The term “aglycone” refers to the noncarbohydrate residue of a glycoside. Aglycones are released by hydrolysis of the glycosidic linkage (here, the linkage between the 0 and R²).

The term “suspension polymerization” refers to a polymerization in which a first phase containing the reaction mixture is suspended in a second, immiscible liquid phase (medium).

When water is used in suspension polymerization, it should be present at about 35 to 80 vol % of the total volume (water plus solvent plus monomers), and preferably at about 50 to 75 vol %, and more preferably at about 70-80 vol %.

The cohesive energy density is a measure of the stabilizing or cohesive effect in condensed phases. What is known as the solubility parameter is the square root of the cohesive energy density and is expressed in units of the square root of MegaPascals (MPa^{1/2}). Values of solubility parameters for a wide variety of polymers and solvents are tabulated in A. F. M. Barton, Handbook of Solubility Parameters and Other Cohesion Parameters, CRC Press, Boca Raton, Fla. (1991) and in J. Brandrup et al., Ed., Polymer Handbook, Second edition, John Wiley & Sons Inc., New York, pp IV-337-IV-359 (1975). While Barton prefers the term “cohesion parameter”, “solubility parameter” has remained the more widely used term, and is used herein.

Many authors have broken the solubility parameter down into components intended to quantify specific types of solute/solvent interactions. Hoy determined polar, hydrogen-bonding, and nonpolar (also known as dispersive) components of a total solubility parameter, δ. The relationship among the components is defined as:

δ²=δ_{d}²+δₚ²+δₕ²

where δ is the total solubility parameter, δ_{d} is the dispersive solubility parameter, δₚ is the polar solubility parameter, and δₕ is the hydrogen-bonding solubility parameter. Hoy solubility parameters are tabulated for a wide variety of materials (see Barton, op cit., pp. 115, 119-138).

For purposes of this invention, it is preferred that the porogen have a Hoy polar solubility parameter between 5 and 12 MPa^{1/2}, more preferably between 7 and 11 MPa^{1/2}, and most preferably between 7.5 and 10 MPa^{1/2}. It is preferred that the suspending medium is not a fluorocarbon.

Preferably, the polymer product resulting from use of the claimed methods has a surface area of at least about 100 m²/g or more (more preferably of about 300 m²/g or more) when measured by nitrogen porosimetry.

Table 1 indicates typical relationships among the elements of the solution and suspension embodiments of the invention, respectively.

TABLE 1

| | Preferred for Solution Product | Preferred for Suspension |
|---|---|---|
| Parameter | Method | Product Method |
| Polym. Temp | 60-70° C. | 60-70° C. |
| Initiator (amt) | Vazo 67 or Vazo 64 | Vazo 67 or Vazo 64 |
| | (0.4-0.7 wt % of organic phase) | (0.4-0.7 wt % of organic |
| | | phase) |
| Porogen (amt) | Hoy polar sol param = 7.5-10 MPa1/2 | EtOAc, toluene |
| | OR | (75 vol % of organic phase) |
| | EtOAc, n-BuOAc, 1-PrOAc, 1- | |
| | pentanol | |
| | (70-80 vol % of organic phase) | |
| Cross-linker (amt) | EGDMA (70-85 mol % of monomers) | EGDMA |
| | | (70-85 mol % of monomers) |
| Functional | MAA (8-10 mol % of monomers) | MAA |
| monomer (amt) | | (8-10 mol % of monomers) |
| Other monomer | Sty (8-10 mol % of monomers) | Sty |
| (amt) | | (8-10 mol % of monomers) |
| Water, amount | NA | 75 vol % of total organic |
| | | phase + H₂O |
| Suspending agent | NA | HEC, |
| (amt) | | (0.07-0.16 wt % vs water) |
| Protective colloid | NA | Gelatin (0.07-0.16 wt % vs |
| (amount) | | water) |

In TABLE 1, EtOAc is ethyl acetate, n-BuOAc is n-butyl acetate, 1-PrOAc is 1-propyl acetate, EGDMA is ethylene glycol dimethacrylate, MAA is methacrylic acid, Sty is styrene, and HEC is hydroxyethyl cellulose.

The present invention is further defined in the following Examples. These Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions

### EXAMPLES

### General Methods

The following compounds and abbreviations were used unless otherwise indicated: methacrylic acid (MAA) at 99% purity (Aldrich); ethylene glycol dimethacrylate (EGDMA) at 98% purity (Aldrich); β-estradiol 3-benzoate (EB) at 98% purity (Sigma); hydroxyethyl cellulose (HEC) of unknown purity, about 200,000 molecular weight (Aldrich #30,863-3); nitrogen (N₂); azo free radical initiator Vazo® 67 (2,2′-Azodi(2-Methylbutyronitrile)) of unknown purity (E. I. du Pont de Nemours and Company); ethyl acetate (EtOAc) at 99.9% purity (EM Omnisolv, EM Science, Gibbstown, N.J.); chloroform (CHCl₃) at 99.9% purity (EM Omnisolv); styrene (Sty) at 99% purity (Aldrich), gelatin (˜175 bloom, Aldrich #27,161-6); heptane at 99.5% purity (EM OmniSolv); toluene at 99.5% purity (EM OmniSolv); 1-hexanol at 98% purity (Aldrich); n-butyl acetate at 99.5% purity (Aldrich); 1-butanol at 99.8% purity (Aldrich); 1-propyl acetate at 99% purity (Aldrich); 1-pentanol at 99+% purity (Aldrich); 1,4-dioxane at 99+% purity (Aldrich); tetrahydrofuran (THF) at 99.5% purity (Aldrich); and p-methoxyphenol (MEHQ) at 99.9% purity (Aldrich). Unless specified, all compounds were used without further purification. The meaning of abbreviations is as follows g, grams; mL, milliliters; L, liters; m, meters; nm, nanometers; rpm, revolutions per minute; ° C., degrees Celsius; hr, hours; min, minutes. “High performance liquid chromatography ” is abbreviated HPLC.

Batch Experiments—Isoflavone Uptake by Polymer:

A known mass of the microporous polymer (typically 0.05-0.6 g) was contacted with a known volume of soy whey (typically 5-50 mL) obtained from Protein Technologies International (St. Louis, Mo.). Samples were placed on a laboratory rotary shaker (typically set at 200 rpm) and shaken at room temperature for 4-24 hr. A portion of the supernatant (typically 1 mL) was withdrawn, filtered, and assayed for isoflavones by HPLC analysis as described below.

Quantitation of Components:

Isoflavones were resolved and quantified at 260 nm using HPLC on a 2.1 mm×100 mm Hypersil ODS column (3 micron stationary phase). Mobile phase A (88:10:2) of water:methanol:glacial acetic acid and Mobile phase B consisted of 98:2 methanol:glacial acetic acid. A flow of 0.2 mL/min was used with a gradient varying from 95% A at t=0 min, 30%A at t=1 min, 0%A at t=16 min, and 95%A at t=19.5 min and remaining time till the end of the 27.5 minute run. Other details of the HPLC procedure are familiar to those skilled in the art. The difference in concentration in the soy whey before and after the experiment was used to estimate the weight of isoflavones adsorbed on the samples.

Adsorption Measurement:

For isoflavone adsorption (e.g., from soy whey), the adsorption data was converted to an aglycone basis as follows:

aglycone mass adsorbed=mass of daidzein adsorbed+mass of glycitein adsorbed+mass of genistein adsorbed+mass of daidzin adsorbed (*MW daidzein/MW daidzin)+mass of glycitin adsorbed (*MW glycitein/MW glycitin)+mass of genistein adsorbed (*MW genistein/MW genistin).

The isoflavone loading (mass isoflavone/mass polymer) is calculated by dividing the concentration difference times the solution volume and dividing by the mass of dry polymer used in the experiment. A plot of the equilibrium concentration of isoflavones, in mg/L and the isoflavone loading on the polymer shows the adsorption isotherm at room temperature for the uptake of isoflavones from soy whey on the polymer sample. The isotherm provides the “isoflavone uptake” data shown in the Figures.

Nitrogen Porosimetry:

The nitrogen adsorption isotherm of the sample was measured and the surface area calculated from the well-known BET adsorption isotherm (Brunauer, Emmett, and Teller, J. Am. Chem. Soc. 60, 309 (1938)). The specific area (area per g of sample) is referred to interchangeably herein as “BET surface area” or “surface area”.

Particle Size Distribution (PSD) Measurement

The PSD was measured using a Microtrac Full-Range Analyzer (FRA) (Leeds & Northrup Instruments, St. Petersburg, Fla.). The operation of this instrument is based on the Fraunhofer scattering model of light interacting with particles of various sizes. Particles were dispersed in water (at about a 1% volume concentration) before they were loaded into the FRA recirculation cell. The reported median diameter by this method gives a diameter for an equivalent volume sphere.

### Example 1

### Polymerization of EGDMA/MAA/Styrene in Various Solvents and Adsorption of Isoflavones

The quantities of chemicals used in this example are summarized in Table 2. The small monomers used were styrene, EGDMA, and MAA. The base monomer, styrene, was 8.7 mol % of the small monomer input. The crosslinker, EDGMA, was 82.7 mol % of the small monomer input. The functional monomer, MAA, was 8.6 mol % of the small monomer input. In sample 1c, the EB template was present at 50.1 mol % versus the MAA monomer.

Solvent (>90 mL) was deoxygenated for at least 30 min by sparging with nitrogen. A 3-neck, 250-mL round-bottom flask was assembled with a reflux condenser, mechanical stirrer (glass rod), and thermocouple-in-well; the condenser was connected to a trap and nitrogen bubbler to maintain a slightly positive pressure. The sparged solvent was added to the flask and the flask flushed with nitrogen. While flushing with nitrogen, the flask was charged with monomers, transferred by syringe. The mixture was stirred and then (with the thermocouple (TC) well removed) briefly deoxygenated again with nitrogen. Then the TC well was placed again onto the 3rd neck of the flask. An oil bath equipped with a TC-controlled heater and over-temperature controller brought the solution to the indicated polymerization temperature with stirring. Soon after the solution reached the polymerization temperature, 0.5 g of the azo initiator (Vazo® 67) was added by very briefly removing the TC well with slight nitrogen flush, to introduce the powder. The reaction was run for 6 hr, with stirring.

The desired conversion of monomers is ˜90% or higher. When the contents gelled, stirring was stopped but the internal temperature was held constant. The polymerization was terminated by opening the system to air, adding 0.05 g of MEHQ (p-methoxyphenol) in 10 mL of reaction solvent, and removing the heat source.

The gelled product was purified by breaking it up in a blender with excess polymerization solvent, vacuum-filtering the particulate polymer suspension, and rinsing the residue several times with polymerization solvent on the filter. The polymer was dried in the fume hood overnight and then in a 65° C. vacuum oven with vacuum and slight nitrogen bleed.

Polymer 1c in Table 2 was imprinted with β-estradiol benzoate (EB) as template, by polymerization in the presence of the template; the other polymers were not. The template removal procedure was used only with those samples prepared in the presence of EB. During the polymer purification in the blender, the solvent and washings were combined and weighed. A weighed portion of the solvent was bottled and later tested for EB template content by HPLC to determine the fraction of template that was removed from the polymer. Any remaining EB was removed from a ˜3.0 g portion of the polymer by extracting it with refluxing CHCl₃ for 6 h in a Soxhlet apparatus. This solvent was also recovered, weighed, and set aside for analysis of EB content by HPLC. The HPLC analyses of the solvents demonstrated that the blender-purification and extraction procedures removed virtually all of the EB from the polymer.

Each polymer's isoflavone adsorption isotherm was measured. From each curve was determined the isoflavone uptake of the corresponding polymer, at points where the concentration of isoflavone left in the aqueous medium was 1 and 5 ppm. These uptake values, (or ‘loadings’) at 1 ppm and 5 ppm are also recorded in Table 2. The polymers prepared in ethyl acetate, with or without EB template, showed isoflavone uptake superior to that prepared in chloroform, at 1 and 5 ppm isoflavone-in-whey concentrations.

TABLE 2

| Sample | 1a | 1b | 1c |
|---|---|---|---|
| Polymerization temp | 70° C. | 60° C. | 70° C. |
| Solvent: ethyl acetate, mL | 90 | — | 90 |
| Solvent, chloroform, mL | — | 90 | — |
| styrene (Sty) mL | 1.10 | 1.10 | 1.10 |
| Cross-linking monomer: ethylene glycol | 17.20 | 17.20 | 17.20 |
| dimethacrylate (EGDMA), mL | | | |
| Functional monomer: methacrylic acid | 0.80 | 0.80 | 0.80 |
| (MAA) mL | | | |
| β-estradiol 3-benzoate (EB), g | 0.00 | 0.00 | 1.78 |
| Isoflavone Uptake | | | |
| (mg isoflavone/g polymer) | | | |
| @ 1 ppm isoflavone concentration in whey | 1.8 | 0.5 | 1.6 |
| @ 5 ppm isoflavone concentration in whey | 6.1 | 2.3 | 5.5* |

*isotherm curve extrapolated to 5 ppm from 4.6 ppm

### Example 2

### Suspension Polymerization of EGDMA/MAA/Styrene with Various Solvent Additives

The quantities of chemicals used in this example are summarized in Table 3.

Excess quantities of solvent and deionized water were deoxygenated for at least 30 min by sparging with nitrogen. The aqueous phase was prepared by stirring the water-soluble ingredients into the designated amount of sparged water under nitrogen in a round-bottom (rb) flask. A 3-neck, round bottom reaction flask (250- or 500-mL as appropriate) was assembled with a reflux condenser, mechanical stirrer (glass rod), and thermocouple-in-well; the condenser was connected to a trap and nitrogen bubbler to maintain a slight positive pressure. When the aqueous phase components were almost completely dissolved in their rb flask, the charging of the separate, 3-neck, reaction flask was begun. While flushing it with nitrogen, the flask was charged with solvent and then monomers, transferred by syringe. 0.2 gram of the azo initiator (Vazo® 67) was added, by very briefly removing the thermocouple (TC) well with slight nitrogen flush, to introduce the powder. The ingredients were carefully and briefly mixed, behind a shield and drawn hood sash. The aqueous phase was added, with nitrogen flush through the flask. The mixture was well stirred and then, with the TC well removed, briefly deoxygenated again with nitrogen. Then the TC well was placed again onto the 3rd neck of the flask. With stirring at 600 rpm, the solution was brought to the desired temperature, 70°, in a ˜80° C. oil bath equipped with a TC-controlled heater and over-temperature controller. The time when the flask approached the desired reaction temperature was noted, as ‘time’. The reaction was run for 6 hr, with stirring. The desired conversion of small monomers was ˜90% or higher. Polymerization was terminated by opening the system to air, adding 0.1 g MEHQ (p-methoxyphenol) in 10 mL of reaction solvent or ethyl acetate (EtOAc), and removing the heat source, stirring while cooling.

The polymer beads were filtered on a coarse filter and washed 3 times, each with 50 mL of deionized water. During all filtrations, vacuum was temporarily shut off when water was added, water was well mixed with the beads, and then vacuum was turned on again to remove the water. The polymer was dried in the fume hood overnight and then in a 65° C. vacuum oven with vacuum and slight nitrogen bleed.

Each polymer's isoflavone adsorption isotherm was measured. The isoflavone uptake of the corresponding polymer was determined from each curve at points where the concentration of isoflavone left in the aqueous medium was 1 and 5 ppm. These uptake values (or ‘loadings’) at 1 ppm and 5 ppm are also recorded in Table 3. The BET surface areas of the polymers were also measured and reported in Table 3.

Polymers prepared in ethyl acetate and toluene showed better uptake of isoflavone than did the polymer prepared without added solvent. For ethyl acetate and toluene, isoflavone uptake was better when the solvent constituted 75 volume % of the organic phase than when it constituted 25 volume %. Polymers prepared in ethyl acetate and toluene generally showed better uptake of isoflavone than did the polymer prepared in heptane, except when the heptane constituted 25 volume % of the organic phase.

The sample particles used in Example 2 were classified as follows:

| Sam- | | | | | | | |
|---|---|---|---|---|---|---|---|
| ple | 2a | 2b | 2c | 2d | 2e | 2f | 2g |
| Par- | medium | coarse | coarse | medium | Medium | fine | finer |
| ticles: | granular | granular | granular | powder | Granular | granular | gran- |
| | | | | | | | ular |

TABLE 3

| Sample | 2a | 2b | 2c | 2d | 2e | 2f | 2g |
|---|---|---|---|---|---|---|---|
| A. Aqueous Phase | | | | | | | |
| Deionized water, mL | 95 | 185 | 95 | 185 | 95 | 185 | 95 |
| Hydroxyethyl cellulose, | 0.15 | 0.28 | 0.14 | 0.14 | 0.07 | 0.14 | 0.14 |
| g (suspending agent) | | | | | | | |
| Gelatin g | 0.15 | 0.28 | 0.14 | 0.14 | 0.07 | 0.14 | 0.14 |
| (protective colloid) | | | | | | | |
| B. Organic Phase | | | | | | | |
| Solvent: ethyl | 0 | 45 | 8 | — | — | — | — |
| acetate, mL | | | | | | | |
| Solvent: heptane, mL | — | — | — | — | — | 45 | 8 |
| Solvent: toluene, mL | — | — | — | 45 | 8 | — | — |
| Styrene (Sty), mL | 1.7 | 0.86 | 1.3 | 0.86 | 1.3 | 0.86 | 1.3 |
| EGDMA, mL | 28.3 | 14.1 | 21.2 | 14.1 | 21.2 | 14.1 | 21.2 |
| Methacrylic acid, mL | 1.3 | 0.64 | 0.95 | 0.64 | 0.95 | 0.64 | 0.95 |
| Ratios: | | | | | | | |
| Vol %, monomer/ | 100% | 25% | 75% | 25% | 75% | 25% | 75% |
| (monomer + solvent) | | | | | | | |
| Vol %, | 25% | 25% | 25% | 25% | 25% | 25% | 25% |
| Organic/(water + | | | | | | | |
| organic) | | | | | | | |
| Wt %, suspending | 0.16% | 0.15% | 0.15% | 0.08% | 0.07% | 0.08% | 0.15% |
| agent/water | | | | | | | |
| Wt %, protective | 0.16% | 0.15% | 0.15% | 0.08% | 0.07% | 0.08% | 0.15% |
| colloid/water | | | | | | | |
| Base monomer, mol % of | 8.2% | 8.4% | 8.4% | 8.4% | 8.4% | 8.4% | 8.4% |
| Small monomer input | | | | | | | |
| Crosslinker, | 83.3% | 83.2% | 83.3% | 83.2% | 83.3% | 83.2% | 83.3% |
| mol % of small | | | | | | | |
| Monomer input | | | | | | | |
| Functional monomer, | 8.5% | 8.4% | 8.3% | 8.4% | 8.3% | 8.4% | 8.3% |
| mol % | | | | | | | |
| Of small monomer input | | | | | | | |
| Base monomer, | 4.7% | 4.8% | 4.8% | 4.8% | 4.8% | 4.8% | 4.8% |
| wt % of small | | | | | | | |
| Monomer input | | | | | | | |
| Crosslinker, | 91.2% | 91.2% | 91.2% | 91.2% | 91.2% | 91.2% | 91.2% |
| wt % of small | | | | | | | |
| Monomer input | | | | | | | |
| Functional monomer, | 4.0% | 4.0% | 3.9% | 4.0% | 3.9% | 4.0% | 3.9% |
| wt % of | | | | | | | |
| Small monomer input | | | | | | | |
| Isoflavone Uptake | | | | | | | |
| (mg isoflavone/g | | | | | | | |
| polymer) | | | | | | | |
| @ 1 ppm isoflavone | 0 | 0.7 | 0.2 | 2.4 | 0.6 | 0.1 | 0.4 |
| concentration in whey | | | | | | | |
| @ 5 ppm isoflavone | 0.02 | 2.5 | 0.6 | 6.2 | 1.5 | 0.4 | 1.6 |
| concentration in whey | | | | | | | |
| BET Surface Area, m²/g | 0.3 | 391 | 0.012 | 388 | 7.5 | 33.1 | 0.1 |
| Solvent (vol % of | — | EtOAc | EtOAc | toluene | Toluene | heptane | heptane |
| organic | | | | | | | |
| Phase) | | (75%) | (25%) | (75%) | (25%) | (75%) | (25%) |

### Example 3

### Polymerization of EGDMA/MAA/Styrene in Various Solvents and Adsorption of Isoflavones

The polymerization solvents used in this example are listed in Table 4. In each case, 90 mL of polymerization solvent was used. The base monomer, styrene, was present at 8.7 mol % of the small monomer input. The crosslinker, EGDMA, was present at 82.7 mol % of the small molecule input. The functional monomer, MAA, was present at 8.6 mol % of the small molecule input.

Solvent (>90 mL) was deoxygenated for at least 30 min by sparging with nitrogen. A 3-neck, 250-mL round-bottom flask was assembled with a reflux condenser, mechanical stirrer (glass rod), and thermocouple-in-well; the condenser was connected to a trap and nitrogen bubbler to maintain a slightly positive pressure. The sparged solvent was added to the flask and the flask flushed with nitrogen. While flushing with nitrogen, the flask was charged with monomers (transferred by syringe), 1.10 mL styrene, 17.20 mL EGDMA, and 0.80 mL MAA. The mixture was stirred and then, with the thermocouple (TC) well removed, briefly deoxygenated again with nitrogen. Then the TC well was placed again onto the 3rd neck of the flask. An oil bath equipped with a TC-controlled heater and over-temperature controller brought the solution to the indicated polymerization temperature, with stirring at 240 rpm. Soon after the solution reached the polymerization temperature, 0.5 g of the azo initiator (Vazo® 67) was added, by very briefly removing the TC well with slight nitrogen flush, to introduce the powder. The reaction was run for 6 hr, with stirring. The desired conversion of monomers is ˜90% or higher. When the contents gelled, stirring was stopped but the internal temperature was held constant. The polymerization was terminated by opening the system to air, adding 0.05 g of MEHQ (p-methoxyphenol) in 10 mL of reaction solvent, and removing the heat source.

The gelled product was purified by breaking it up in a blender for 5 min with 500 mL of ethyl acetate (EtOAc), vacuum-filtering the particulate polymer suspension through a coarse-frit filter covered with Whatman #1 paper, and rinsing the residue 4 times with 100 mL of EtOAc on the filter. Vacuum was temporarily shut off when wash solvent was added, then turned on again and polymer/solvent stirred to mix. The polymer was dried in the fume hood overnight and then in a 65° C. vacuum oven with vacuum and slight nitrogen bleed.

Each polymer's isoflavone adsorption isotherm was measured. The isoflavone uptake of each polymer was determined from the corresponding curve at points where the concentration of isoflavone left in the aqueous medium was 1 and 5 ppm. These uptake values (or ‘loadings’) at 1 ppm and 5 ppm are also recorded in Table 4. All of the solvents used in Examples 3a to 3i gave polymers with higher isoflavone loadings at 1 and 5 ppm than the polymer prepared in chloroform (sample 1b in Example 1). However, the polymer prepared in 1-butanol at 60/70° C. did not perform as well as the chloroform polymer at higher isoflavone-in-whey concentrations of about 10-15 ppm.

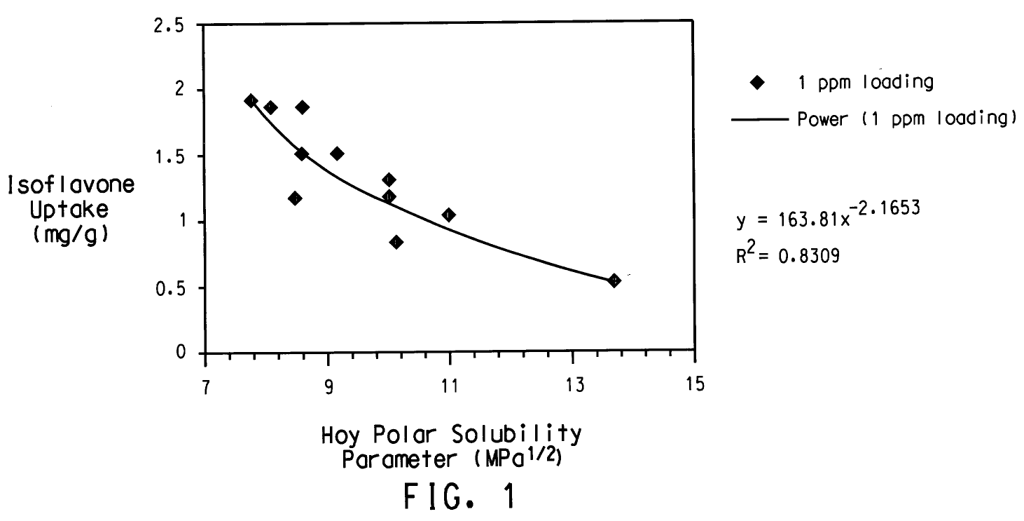

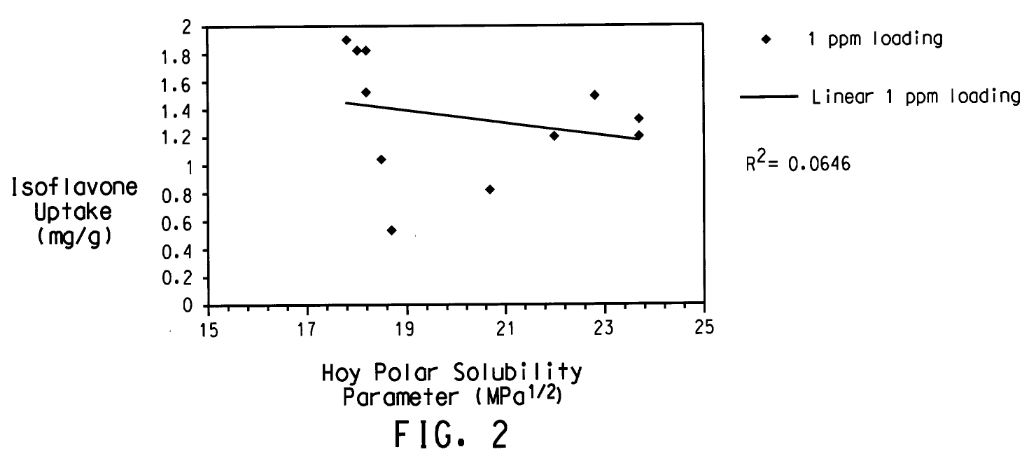

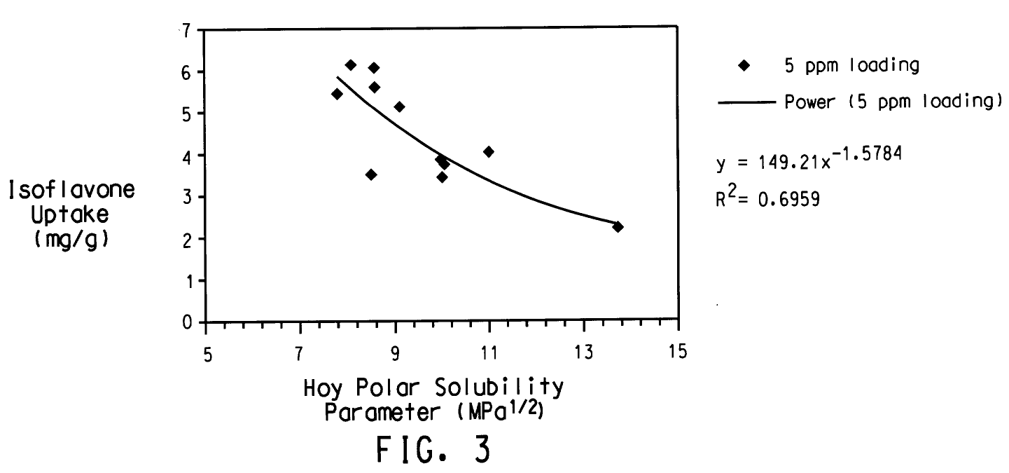

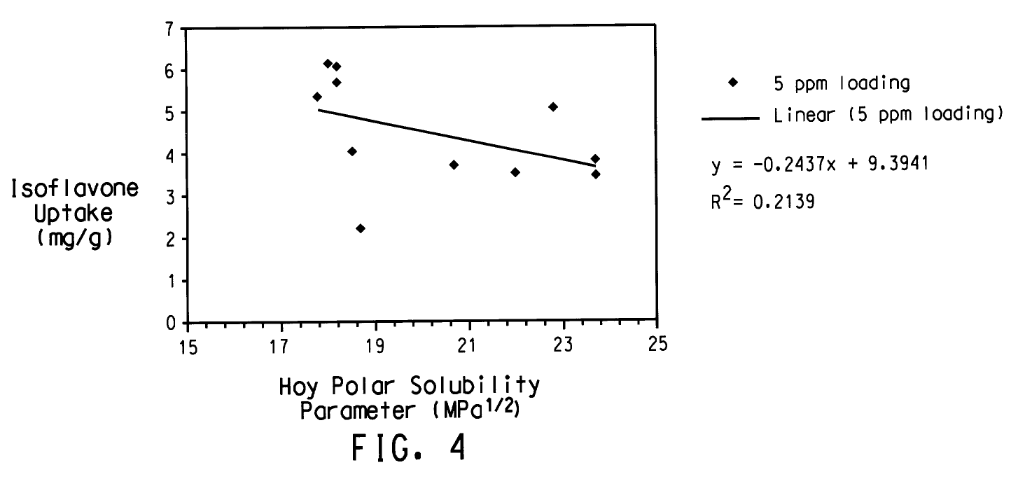

The isoflavone uptake values for samples 1a, 1b, and 3a through 3i were checked for statistically significant correlations with the Hoy solubility parameter (Table 4, and FIGS. 1, 2, 3, and 4). Isoflavone uptake clearly depends strongly on the polar solubility parameter, while there is no such dependence on the total solubility parameter.

TABLE 4

| | | | | | Total | Polar |
|---|---|---|---|---|---|---|
| | Polymerization | | | | Solubility | Solubility |
| | Temperature | | Uptake | Uptake | Parameter | Parameter |
| Sample | (deg. C.) | Solvent | @ 1 ppm | @ 5 ppm | (MPa^{1/2}) | (MPa^{1/2}) |
| 3c | 70 | Butyl acetate | 1.90 | 5.42 | 17.8 | 7.8 |
| 3e | 70 | 1-propyl acetate | 1.83 | 6.15 | 18.0 | 8.1 |
| 1a | 70 | Ethyl acetate | 1.82 | 6.10 | 18.2 | 8.6 |
| 3a | 60 | Ethyl acetate | 1.52 | 5.66 | 18.2 | 8.6 |
| 3f | 70¹ | 1-pentanol | 1.50 | 5.10 | 22.8 | 9.1 |
| 3d | 70¹ | 1-butanol | 1.32 | 3.79 | 23.7 | 10.0 |
| 3b | 70 | 1-hexanol | 1.21 | 3.50 | 22.0 | 8.5 |
| 3i | 60/70² | 1-butanol | 1.20 | 3.42 | 23.7 | 10.0 |
| 3h | 60 | THF | 1.05 | 4.07 | 18.5 | 11.0 |
| 3g | 70 | 1,4-dioxane | 0.82 | 3.65 | 20.7 | 10.1 |
| 1b | 60 | Chloroform | 0.53 | 2.30 | 18.7 | 13.7 |

¹Polymerizations in butanol and pentanol evolved heat early and strongly. In butanol, temperature rose to ˜92° C. In pentanol, temperature was better restrained by faster oil-bath temperature compensation.
²Polymerization started at 60° C. to compensate for strong exotherm, to stop temp rise to 90° C.; maintained at 70° C. after exotherm.

What is claimed is:

1. A method for preparing a porous polymer adsorbent comprising:
contacting a polymerization initiator with a reaction mixture comprising
(i) at least 25 mol % of one or more polyfunctional methacrylate monomers, each monomer containing at least three methacrylate groups, or at least 50 mole % of one or more dimethacrylate monomers, or a mixture thereof,
(ii) between about 5 to 25 mol % of one or more acid monomers,
(iii) optionally, one or more polymerizable monomers selected from the group consisting of styrene, phenoxyethyl methacrylate, alkyl methacrylate, and arylalkyl methacrylates; and
(iv) a porogenic solvent having a Hoy polar solubility parameter ranging from about 12 to about 5 MPa^{1/2} and comprising at least 25% by volume of the organic phase of the reaction mixture.

2. The method of claim 1 wherein the polymerization initiator is heat, light, azo free radical compounds, peroxides, or a redox system.

3. The method of claim 1 wherein the porogenic solvent comprises at least 50 vol % of the organic phase of the reaction mixture.

4. The method of claim 3 wherein the porogenic solvent comprises at least 70 vol % of the organic phase of the reaction mixture.

5. The method of claim 1 wherein the porogenic solvent is an alkyl acetate wherein the alkyl group contains between 1 and 10 carbon atoms or is an alcohol containing between 4 and 10 carbon atoms.

6. The method of claim 5 wherein the porogenic solvent is ethyl acetate, propyl acetate, or butyl acetate.

7. The method of claim 5 wherein the porogenic solvent is 1-butanol, 1-pentanol, or 1-hexanol.

8. The method of claim 1 wherein the porogenic solvent has a Hoy polar solubility parameter ranging from about 7 to about 11 MPa^{1/2}.

9. The method of claim 1 wherein the porogenic solvent has a Hoy polar solubility parameter ranging from about 7.5 to about 10 MPa^{1/2}.

10. The method of claim 1 wherein the acid monomer is selected from the group consisting of methacrylic acid, acrylic acid, itaconic acid, maleic acid, fumaric acid, cinnamic acid, and p-hydroxycinnamic acid.

11. The method of claim 1 wherein the polymerizable monomer is selected from the group consisting of styrene, phenoxyethyl methacrylate, alkyl methacrylate, and arylalkyl methacrylate.

12. The method of claim 1 wherein the reaction mixture further comprises water.

13. The method of claim 12 wherein the reaction mixture further comprises a suspending agent at 0.05-1% by weight of the water, a protective colloid at 0.05-1% by weight of the water, and/or aqueous additive(s).

14. The method of claim 13 wherein the suspending agent is selected from the group consisting of hydroxyethyl cellulose, hydroxymethyl cellulose, hydroxypropyl cellulose, carboxymethyl cellulose, poly(vinyl alcohol), sodium lauryl sulfate, sodium polyacrylate, polyacrylic acid, polymethacrylic acid, sodium polymethacrylate, and dodecyl alcohol.

15. A method for separating isoflavones from an aqueous medium comprising
(a) contacting an aqueous medium containing isoflavones with a porous polymer produced by the method of claims 1 or 12 for a time sufficient to adsorb the isoflavones onto the porous polymer; and
(b) desorbing the isoflavones from the porous polymer.

16. A method for preparing a microporous polymer adsorbent comprising
a) contacting
(1) an azo free radical compound at 0.4-0.7 wt % of total of organic phase with
(2) a reaction mixture comprising
(i) ethylene glycol dimethacrylate at about 70-80 mol % of the total monomers;
(ii) styrene at about 8-10 mol % of the total monomers;
(iii) methacrylic acid at about 8-10 mol % of the total monomers; and
(iv) a porogenic solvent having a Hoy polar solubility parameter ranging from about 7.5 to about 10 MPa^{1/2} and at least 25% by volume of the organic phase of the reaction mixture;
b) separating the microporous polymeric adsorbent resulting from the reaction mixture of step a).

17. The method of claim 16 wherein the porogenic solvent is EtOAc, n-BuOAc, 1-PrOAc, or 1-pentanol at about 70-80 vol % of the organic phase.

18. The method of claim 17 wherein the azo free radical compound is 2,2′-Azodi(2-Methylbutyronitrile).

19. A method for preparing a microporous polymeric adsorbent comprising
(a) contacting
(1) an azo free radical compound at 0.4-0.7 wt % of an organic phase with
(2) a reaction mixture comprising
(i) ethylene glycol dimethacrylate at about 70-80 mol % of the total monomers;
(ii) styrene at about 8-10 mol % of the total monomers;
(iii) methacrylic acid about 8-10 mol % of the total monomers; and
(iv) a porogenic solvent having a Hoy polar solubility parameter ranging from about 7.5-10 MPa^{1/2} and at least 25% by volume of the organic phase of the reaction mixture, in an aqueous solution comprising
(i) water at about 70-80 vol %of the total of the organic phase and water;
(ii) one or more suspending agents selected from the group consisting of hydroxyethyl cellulose, hydroxymethyl cellulose, hydroxypropyl cellulose, carboxymethyl cellulose, poly(vinyl alcohol), sodium lauryl sulfate, sodium polyacrylate, polyacrylic acid, polymethacrylic acid, sodium polymethacrylate, and dodecyl alcohol at about 0.07-0.16 wt %/water; and
(iii) gelatin at about 0.07-0.16 wt %/water,
(b) separating the microporous polymeric adsorbent resulting from the reaction mixture of step (a).

20. The method of claim 19 wherein the porogenic solvent is ethyl acetate or toluene at about 70-80 vol % of the organic and aqueous phases.

21. The method of claim 20 wherein the azo free radical compound is 2,2′-Azodi(2-Methylbutyronitrile).

22. The method of claim 21 wherein the suspending agent is hydroxyethyl cellulose.
